(19) United States
(12) Patent Application Publication
(10) Pub. No.: US 2026/0073592 A1
(43) Pub. Date: Mar. 12, 2026

(54) METHOD, APPARATUS, DEVICE, AND STORAGE MEDIUM FOR IMAGE GENERATION

(71) Applicant: Beijing Zitiao Network Technology Co., Ltd., Beijing (CN)

(72) Inventors: Jie Wu, Beijing (CN); Xuefeng Xiao, Beijing (CN)

(21) Appl. No.: 19/280,891

(22) Filed: Jul. 25, 2025

(30) Foreign Application Priority Data
Sep. 9, 2024 (CN) 202411260014.7

(51) Int. Cl. G06T 11/60; G06T 3/40; G06T 5/60; G06T 5/70

(52) U.S. Cl. CPC G06T 11/60; G06T 3/40; G06T 5/60; G06T 5/70; G06T 2207/20081; G06T 2210/36

(57) ABSTRACT

The embodiments of the disclosure provide a method, apparatus, device, and storage medium for image generation. The method includes obtaining a trained first image generation model, the first image generation model being configured to generate an image having a first resolution. A second image generation model is obtained by training the first image generation model using second training data, the second training data includes an image having a second resolution, the second image generation model is configured to generate an image having the second resolution, and the second resolution is higher than the first resolution.The second image generation model is trained with a second reward model.

### CROSS-REFERENCE

This application claims priority to Chinese Patent Application No. 202411260014.7, filed on September 09, 2024, and entitled “METHOD, APPARATUS, DEVICE, AND STORAGE MEDIUM FOR IMAGE GENERATION”, the entirety of which is incorporated herein by reference.

### FIELD

Example embodiments of the present disclosure generally relate to the field of computers, and in particular, to a method, an apparatus, a device, and a computer-readable storage medium for image generation.

### BACKGROUND

As machine learning technologies become more and more mature, image generation models based on machine learning technologies in generative applications are widely used. The image generation model can be used to generate a variety of images required, which greatly meets multiple image generation needs of users in various industries. In an image generation model application, generation of a high-resolution image becomes an important concern.

### SUMMARY

In a first aspect of the present disclosure, a method for image generation is provided. The method includes: obtaining a trained first image generation model, the first image generation model being configured to generate an image having a first resolution; obtaining a second image generation model by training the first image generation model using second training data, the second training data including an image having a second resolution, the second image generation model being configured to generate an image having the second resolution, and the second resolution being higher than the first resolution; and training the second image generation model with a second reward model.

In a second aspect of the present disclosure, a method for image generation is provided. The method includes: obtaining a description text for an image generation target; generating, based on the description text, a first image having a first resolution with a first image generation model; and generating, based on the first image, a second image having a second resolution with a second image generation model, the second resolution being greater than the first resolution, and the second image generation model being trained according to the method of the first aspect.

In a third aspect of the present disclosure, an apparatus for image generation is provided. The apparatus includes: an obtaining module configured to obtain a trained first image generation model, the first image generation model being configured to generate an image having a first resolution; a first training module configured to obtain a second image generation model by training the first image generation model using second training data, the second training data including an image having a second resolution, the second image generation model being configured to generate an image having the second resolution, and the second resolution being higher than the first resolution; and a second training module configured to train the second image generation model with a second reward model.

In a fourth aspect of the present disclosure, an apparatus for image generation is provided. The apparatus includes: an obtaining module configured to obtain a description text for an image generation target; a first image generation module configured to generate, based on the description text, a first image having a first resolution with a first image generation model; and a second image generation module configured to generate, based on the first image, a second image having a second resolution with a second image generation model, the second resolution being greater than the first resolution, and the second image generation model being trained by the apparatus according to the third aspect.

In a fifth aspect of the present disclosure, an electronic device is provided. The electronic device includes: at least one processor; and at least one memory coupled to the at least one processor and storing instructions for execution by the at least one processor, the instructions, when executed by the at least one processor, causing the electronic device to perform the method of the first aspect.

In a sixth aspect of the present disclosure, a computer-readable storage medium is provided. The computer-readable storage medium having stored thereon a computer program executable by a processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure can be implemented;

FIG. 2 illustrates an architecture diagram of an example of a training system for a second image generation model according to some embodiments of the present disclosure;

FIG. 3 illustrates an architecture diagram of an example of a training system for a first image generation model according to some embodiments of the present disclosure;

FIG. 4 illustrates an architecture diagram of an example of a model for image generation according to some embodiments of the present disclosure;

FIG. 5 illustrates a schematic diagram of an example of a graphics memory optimization scheme according to some embodiments of the present disclosure;

FIG. 6 illustrates a schematic diagram of another example of a graphics memory optimization scheme according to some embodiments of the present disclosure;

FIG. 7 illustrates a schematic architecture diagram of a model for image generation according to some embodiments of the present disclosure;

FIG. 8 illustrates a flowchart of a process for image generation according to some embodiments of the present disclosure;

FIG. 9 illustrates a flowchart of a process for image generation according to some embodiments of the present disclosure;

FIG. 10 illustrates a block diagram of an apparatus for image generation according to some embodiments of the present disclosure;

FIG. 11 illustrates a block diagram of an apparatus for image generation according to some embodiments of the present disclosure; and

FIG. 12 illustrates a block diagram of a device capable of implementing various embodiments of the present disclosure.

### DETAILED DESCRIPTION

It can be understood that, before the technical solutions disclosed in the embodiments of the present disclosure are used, a user should be notified of the type of the personal information, the usage scope, the usage scenario, and the like related to the present disclosure and the authorization of the user should be obtained in an appropriate manner according to the relevant legal regulations.

For example, in response to receiving an active request from a user, prompt information is sent to the user to explicitly prompt the user that an operation requested by the user to be executed will need to acquire and use personal information of the user. Therefore, the user can autonomously select, according to the prompt information, whether to provide personal information to software or hardware such as an electronic device, an application, a server, or a storage medium that executes the operation of the technical solution of the present disclosure.

As an optional but non-limiting implementation, in response to receiving an active request of the user, a manner of sending prompt information to the user may be, for example, a pop-up window manner, and the prompt information may be presented in a text manner in the pop-up window. In addition, the pop-up window may further carry a selection control for the user to select “agree” or “disagree” to provide personal information to the electronic device.

It may be understood that the foregoing notification and the process of obtaining a user’s authorization are merely illustrative, which do not limit the implementation of the present disclosure, and other manners meeting relevant legal regulations may also be applied to implementation of the present disclosure.

It may be understood that the data involved in the technical solution (including but not limited to the data itself, the obtaining or use of the data) should comply with the requirements of the corresponding legal regulations and related provisions.

Embodiments of the present disclosure will be described in more detail below with reference to the accompanying drawings. Although certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are only for illustrative purposes and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with any other embodiment described in the same section/subsection and/or in different sections/subsections.

Herein, unless explicitly stated otherwise, “performing a step responding to A” does not mean that the step is performed immediately after “A”, but one or more intermediate steps may be included.

In the description of the embodiments of the present disclosure, the terms “including” and the like should be understood as open-ended including, that is, “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first”, “second”, and the like may refer to different or identical objects. Other explicit and implicit definitions may also be included below.

As used herein, the term “model” may learn associations between the corresponding inputs and outputs from training data, so that a corresponding output may be generated for a given input after training is completed. The generation of the model may be based on machine learning techniques. Deep learning is a machine learning algorithm that processes an input and provides a corresponding output by using a multi-layer processing unit. As used herein, “model” may also be referred to as a “machine learning model”, a “machine learning network”, or a “network”, which terms can be used interchangeably herein. A model may in turn include different types of processing units or networks.

As mentioned briefly above, the image generation model is widely used in the generative application. The image generation model, for example, a text-to-image generation model, may generate an image that meets a user’s requirements according to the text input by the user. At present, the image generation model has a good effect in generating a low-resolution image (for example, an image with a pixel resolution of 256 × 256 or a pixel resolution of 512 × 512), and may generate an image desired by the user. However, it is not good enough in generating a high-resolution image (for example, an image with a pixel resolution of 1024 × 1024 or a pixel resolution of 2048 × 2048) to meet the user's expectations, that is, the generated high-resolution image cannot match well with the human intention. How to make the model to obtain a better effect in a super-resolution task becomes an urgent problem to be solved. In the super-resolution task, the selection of an initial model and a signal-to-noise ratio, as well as the sampling strategy and the graphics memory optimization are all the problems that need to be solved.

Embodiments of the present disclosure provide a scheme for image generation. According to various embodiments of the present disclosure, a trained first image generation model is obtained, and the first image generation model is configured to generate an image having a first resolution. A second image generation model is obtained by training the first image generation model using second training data, the second training data includes an image having a second resolution, the second image generation model is configured to generate an image having the second resolution, and the second resolution is higher than the first resolution. The second image generation model is trained with a second reward model.

In an embodiment of the present disclosure, a low-resolution image generation model is first obtained, and then a fine-tuned high-resolution image generation model is obtained by training the low-resolution image generation model. Then, the fine-tuned high-resolution image generation model is fine adjusted with the reward model. Therefore, the image generation model fine adjusted by the reward model can be obtained, so that the performance of the high-resolution image generation model is improved, enabling the high-resolution image generation model to better match the user expectation. In this way, the obtained image generation model can obtain a better effect in the super-resolution task. In particular, in some embodiments, the trained first image generation model is also trained by a reward model, so that the final image generation model has a user expectation effect in the super-resolution task.

### Example Environment

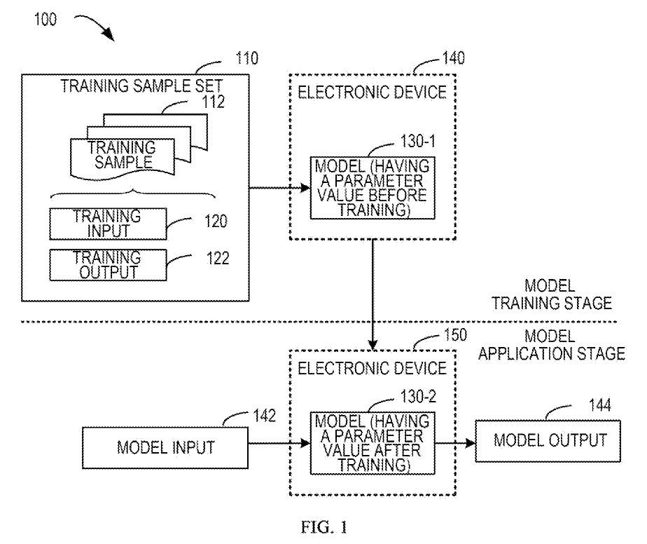

FIG. 1 illustrates a schematic diagram of an example environment 100 in which embodiments of the present disclosure can be implemented. As shown in FIG. 1, a model 130 -1 having a parameter value before training and a model 130 -2 having a parameter value after training may be collectively or individually referred to as a model 130. The model 130 may be included in an electronic device 140 and/or an electronic device 150.

In environment 100 of FIG. 1, it is desirable to train and use such a machine learning model (i.e., model 130), the model 130 is configured for a variety of application environments. For example, when the model is an image generation model, an image corresponding to a text instruction may be generated based on the text instruction input by the user.

As shown in FIG. 1, the environment 100 includes the electronic device 140 and the electronic device 150. There may be a model training system in the electronic device 140, and there may be a model application system in the electronic device 150. The upper part of FIG. 1 shows a process of the model training stage, and the lower part shows a process of the model application stage. Before training, the parameter value of the model 130 may have an initial value, or may have a pre-trained parameter value obtained through a pre-training process. The model 130-1 may be trained via forward propagation and backpropagation, and the parameter value of the model 130-1 may be updated and adjusted during the training process. The model 130-2 may be obtained after the training is complete. The training of the model may further include pre-training and fine adjustment/fine-tuning. Through the pre-training, the model 130-1 has a generalization capability, for example, a capability of processing an image according to an input text instruction. Then, during the fine adjustment/fine-tuning stage, for a downstream image generation task, fine adjustment/fine-tuning is performed on the pre-training model 130-1. At this point, the parameter value of the model 130-2 has been updated, and based on the updated parameter value, the model 130-2 may be used to implement an image processing task, such as an image generation task, during the model application stage.

During the fine adjustment/fine-tuning stage of model training, the model 130 may be trained based on a training sample set 110 including a plurality of training samples 112 and by using a model training system. Herein, each training sample 112 may relate to a 2-tuple format. For example, for an image generation task, the training sample 112 may include a training input 120 and a training output 122 in the image generation task. The training input in the image generation task may include, for example, a training text and an image corresponding to the training text. The training sample 112 including training input 120 and training output 122 may be used to train the model 130. Specifically, the training process may be iteratively performed with a large number of training samples. After the training is complete, the model 130 may have knowledge about the image generation task. During the model application stage, the model 130 (at this point, the model 130 has a trained parameter value) may be used to perform a corresponding task. For example, a model input 142 in an image generation task may be received and a corresponding model output 144 may be output.

In FIG. 1, the electronic device 140 and the electronic device 150 may include any computing system having computing capability, such as various computing devices/systems, terminal devices, servers, and the like. The terminal device may relate to any type of mobile terminal, fixed terminal, or portable terminal, including a mobile phone, a desktop computer, a laptop computer, a notebook computer, a netbook computer, a tablet computer, a media computer, a multimedia tablet, or any combination thereof, including accessories and peripherals of these devices, or any combination thereof. The servers include, but are not limited to, a mainframe, an edge computing node, a computing device in a cloud environment, and the like.

It should be understood that the components and arrangements in the environment 100 shown in FIG. 1 are merely examples, and that the computing system suitable for implementing the example implementations described in the present disclosure may include one or more different components, other components, and/or different arrangements. Implementations of the present disclosure are not limited in this respect. Embodiments of the present disclosure mainly relate to a training stage of an image generation model.

It should be understood that the structure and function of the environment 100 is described for illustrative purposes only and does not imply any limitation to the scope of the present disclosure.

Some example embodiments of the present disclosure will be described below with continued reference to the accompanying drawings.

### Overall Architecture for Model Training

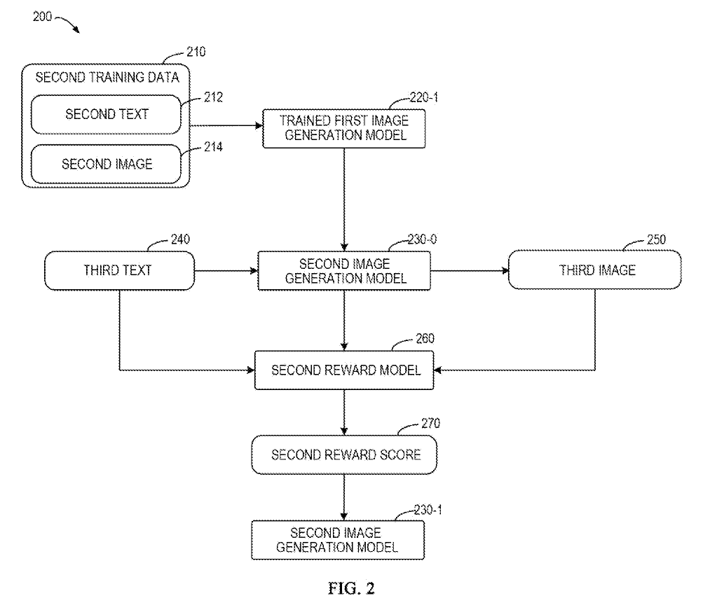

FIG. 2 illustrates an architecture diagram of an example of a training system 200 for a second image generation model according to some embodiments of the present disclosure. As shown in FIG. 2, the training system 200 for the second image generation model may be implemented or included in the electronic device 140.

In some embodiments, the electronic device obtains a trained first image generation model 220-1, and uses second training data 210 to train the trained first image generation model 220-1 to obtain a second image generation model 230.

In some embodiments, the trained first image generation model 220-1 is configured to generate an image having a first resolution. The first resolution is, for example, a pixel resolution of 256 × 256 or a pixel resolution of 512 × 512. It should be understood that the specific values of the resolutions recited herein are illustrative only and are not intended to be limiting in any way. In the present disclosure, the first resolution is also referred to as a low resolution.

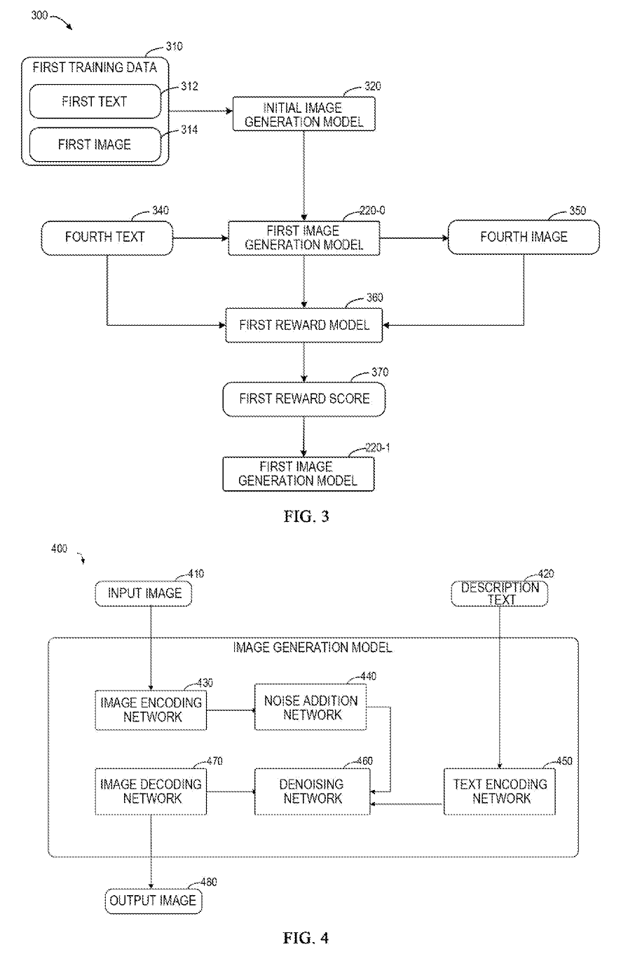

In some embodiments, the trained first image generation model 220-1 may have a pre-trained parameter value obtained through a pre-training process, or may have a fine-tuned parameter value obtained through a fine-tuning process, or may have a parameter value obtained through a reward model training process and fine adjusted via a human feedback. The obtaining process of the trained first image generation model 220-1 is described later in connection with FIG. 3, and details are not described herein again.

In some embodiments, the trained first image generation model 220-1 is a model trained with a reward model, which may be, for example, a model fine adjusted via the human feedback, so that the finally obtained second image generation model has better performance and effect in a super-resolution task or a high-resolution image generation task. In other words, by using the model trained with the reward model, for example, using a model fine adjusted via the human feedback, as an initial model of the super-resolution task, it may help the model used for the super-resolution task to be more stable in the training process of the high-resolution image generation task or the super-resolution task, and to ensure the reliability of the model for the super-resolution task.

In some embodiments, the second image generation model 230 is configured to generate an image having a second resolution. The second resolution is higher than the first resolution. The second resolution is, for example, a pixel resolution of 1024 × 1024 or a pixel resolution of 2048 × 2048. In the present disclosure, the second resolution is also referred to as a high resolution.

In some embodiments, the trained first image generation model 220-1 may be trained using the second training data 210 to obtain the second image generation model 230. In the example of FIG. 2, the second training data 210 includes a second text 212 and a second image 214 corresponding to the second text 212. The second image 214 is an image having a second resolution. The second text 212 may be a descriptive text for an image generation target, such as “a little white cat and a little black dog”. The second image 214 is, for example, a picture with a little white cat and a little black dog corresponding to “a little white cat and a little black dog”.

The trained first image generation model 220-1 may generate a prediction image based on the second text 212. The parameter of the trained first image generation model 220-1 is then adjusted by comparing the prediction image with the second image 214. For example, a prediction image is generated based on the text “a little white cat and a little black dog”, then the prediction image is compared with the second image 214 (a picture with a little white cat and a little black dog), and the parameter of the trained first image generation model 220-1 is adjusted according to the comparison result.

In some embodiments, the trained first image generation model 220-1 may obtain a noise image by performing diffusion and noise addition on the second image 214. Then, the first image generation model 220-1 performs denoising on the obtained noise image based on the second text 212 to obtain the prediction image. The parameter of the trained first image generation model 220-1 is then adjusted by comparing the noise image with the prediction image.

It should be understood that the manner of training the trained first image generation model 220-1 using the second training data 210 is not limited to the manner described above, and that various training manners existing in the art or developed in the future may be employed to train the trained first image generation model 220-1 using the second training data 210, to obtain the second image generation model 230. In the present disclosure, the second image generation model 230 is also referred to as a fine-tuned high-resolution image generation model or a high-resolution fine-tuned model.

After the electronic device obtains the second image generation model 230-0, the second image generation model 230-0 may be trained with a second reward model 260 to obtain a second image generation model 230-1. In the present disclosure, the second image generation model 230-1 is also referred to as a high-resolution image generation model fine adjusted via human feedback or a high-resolution human feedback fine adjusted model. In the present disclosure, the second image generation model 230 and the second image generation model 230-1 may also be collectively referred to as the second image generation model. The third text 240 may be a description text for an image generation target. The third text 240 may be the same as the second text 212, or may be different from the second text 212. In some embodiments, the third text 240 may be a portion of the second text 212. The third image 250 may be a prediction image generated by the second image generation model 230 corresponding to the third text 240.

The second reward model 260 may score the data pair consisting of the third text 240 and the third image 250 to obtain a second reward score 270. The electronic device may adjust the parameter of the second image generation model 230-0 based on the second reward score 270, so as to obtain the second image generation model 230-1. That is, the electronic device may fine adjust the second image generation model 230 with the trained second reward model 260, to improve the performance of the second image generation model 230.

In some embodiments, for the same third text 240, a plurality of third images 250 may be generated by the second image generation model 230. In this case, the second reward model 260 may respectively score the plurality of third images 250 to obtain a plurality of second reward scores 270, and then the electronic device fine adjust the second image generation model 230 based on the plurality of second reward scores 270, to improve the performance of the second image generation model 230.

In some embodiments, the second reward model 260 may use a simple binary reward signal, for example, using a “+” or “-” symbol to represent a reward or penalty given, that is, the score of the reward model, for example, the second reward score 270 is 0 or 1.

In some embodiments, the second reward model 260 may use an integer between 0 and 5 to represent the score of the reward model. For example, the second reward score 270 is an integer between 0 and 5, where 5 represents the highest reward, and 0 represents the lowest reward. Such a reward signal enables the model to better understand whether the generated picture is good or poor, and helps to improve the performance of the model during subsequent adjustment stages.

The second reward model 260 may be implemented by using any suitable network structure. For example, an ALT CLIP (Adaptively Learned Text-Image Contrastive Learning) model may be used as the second reward model 260. The similarity score output by the ALT CLIP model generally refers to the degree of matching between the text description and the generated image.

The above describes the training of the second image generation model by using the trained first image generation model as a starting point. An example embodiment of training of the first image generation model is described below.

FIG. 3 illustrates an architectural diagram of an example of a training system 300 for a first image generation model according to some embodiments of the present disclosure. As shown in FIG. 3, the training system 300 for the first image generation model may be implemented or included in the electronic device 140.

In some embodiments, the electronic device obtains an initial image generation model 320, and trains the initial image generation model 320 using first training data 310 to obtain the first image generation model 220-0.

In some embodiments, the initial image generation model 320 may be a model obtained through pre-training. That is, the initial image generation model 320 may have a pre-trained parameter value obtained through a pre-training process.

In some embodiments, the first training data 310 includes a first text 312 and a first image 314 corresponding to the first text 312. The first image 314 is an image having a first resolution. The first text 312 may be a description text for the image generation target, for example, “a little white cat and a little black dog”. The first image 314 is, for example, a picture with a little white cat and a little black dog corresponding to “a little white cat and a little black dog”.

In some embodiments, the initial image generation model 320 may generate a prediction image based on the first text 312, and then adjust the parameter of the initial image generation model 320 by comparing the prediction image with the first image 314. For example, a prediction image is generated based on the text “a little white cat and a little black dog”, then the prediction image is compared with the first image 314 (a picture with a little white cat and a little black dog), and the parameter of the initial image generation model 320 is adjusted according to the comparison result.

In some embodiments, the initial image generation model 320 may perform diffusion and noise addition based on the second image 214 to obtain a noise image, then perform denoising on the noise image based on the second text 212 to obtain a prediction image, and then adjust the parameter of the initial image generation model 320 by comparing the noise image with the prediction image.

It should be understood that the manner of training the initial image generation model 320 using the first training data 310 is not limited to the manner described above, and that various training manners existing in the art or developed in the future may be employed to train the initial image generation model 320 using the first training data 310 to obtain the first image generation model 220-0. In the present disclosure, the first image generation model 220-0 is also referred to as a fine-tuned low-resolution image generation model or a low-resolution fine-tuned model.

After the electronic device obtains the first image generation model 220-0, the first image generation model 220-1 is obtained by training the first image generation model 220-0 with a first reward model 360. In the present disclosure, the first image generation model 220-1 is also referred to as a low-resolution image generation model fine adjusted via a human feedback or a low-resolution human feedback fine adjusted model. In the present disclosure, the first image generation model 220-0 and the first image generation model 220-1 may also be collectively referred to as the first image generation model.

The fourth text 340 may be a description text for an image generation target. The fourth text 340 may be the same as the first text 312, or may be different from the first text 312. In some embodiments, the fourth text 340 may be a portion of the first text 312. The fourth image 350 may be a prediction image generated by the first image generation model 220-0 corresponding to the fourth text 340.

The first reward model 360 may score the data pair consisting of the fourth text 340 and the fourth image 350 to obtain a first reward score 370. The electronic device may adjust the parameter of the first image generation model 220-0 based on the first reward score 370, to obtain the first image generation model 220-1. That is, the electronic device may fine adjust the first image generation model 220-0 with the trained first reward model 360, to improve the performance of the second image generation model 220-0.

In some embodiments, for the same fourth text 340, a plurality of fourth images 350 may be generated by the first image generation model 220-0. In this case, the first reward model 360 may respectively score the plurality of fourth images 350 to obtain a plurality of first reward scores 370, and then the electronic device fine adjust the first image generation model 220-0 based on the plurality of first reward scores 370, to improve the performance of the first image generation model 220-0.

In some embodiments, the first reward model 360 may use a simple binary reward signal, for example, using a “+” or “-” symbol to represent a reward or penalty given, that is, the score of the reward model, for example, the first reward score 370 is 0 or 1.

In some embodiments, the first reward model 360 may use an integer between 0 and 5 to represent the score of the reward model. For example, the first reward score 370 is an integer between 0 and 5, where 5 represents the highest reward, and 0 represents the lowest reward. Such a reward signal enables the model to better understand whether the generated the picture is good or bad, and helps to improve the performance of the model during subsequent adjustment stages.

Any suitable network structure may be employed to implement the first reward model 360. For example, an ALT CLIP model may be used as the first reward model 360, and the similarity score output by the ALT CLIP model generally refers to the degree of matching between the text description and the generated image.

In such embodiments, the initialization of the super-resolution model is performed by fine tuning and human feedback fine adjusting the low resolution image generation model. Compared with fine-tuning and human feedback fine adjusting directly on the high-resolution model, such initialization manner can enable the super-resolution model to be trained more stably in subsequent super-resolution tasks and ensure the reliability of image generation structure of the super-resolution model.

In some embodiments, the first image generation model (220-0, 220-1) and the second image generation model (230, 230-1) may employ a Diffusion Model, such as a DDPM (Denoising Diffusion Probabilistic Models), a Latent Diffusion Mode, or a Stable Diffusion model. An example architecture of the diffusion model is described below in conjunction with FIG. 4.

FIG. 4 illustrates an architectural diagram of an example of a model for image generation according to some embodiments of the present disclosure. As shown in FIG. 4, in some embodiments, the image generation model (for example, the first image generation model or the second image generation model) includes an image encoding network 430, a noise addition network 440, a text encoding network 450, a denoising network 460, and an image decoding network 470.

The image encoding network 430 is configured to perform image encoding on the obtained input image 410 to obtain a corresponding image feature. In some embodiments, the image encoding network 430 may employ, but is not limited to, a Variational AutoEncoder (VAE), and the VAE maps the input image 410 to a latent feature space to obtain a corresponding image feature Z.

The noise addition network 440 is configured to perform diffusion and noise addition on the image feature Z, and project the image feature Z into a latent space to obtain a latent space vector, so as to obtain a corresponding noise added image feature, that is, the noise image feature Z_{T}, where T represents the number of diffusion, or the number of the time steps. That is, in the noise addition network 440, the noise image feature Z_{T} is generated through T times of diffusion processes for the image feature Z, Z_{T} represents a latent space value at T moment.

In some embodiments, the noise addition network 440 randomly adds a Gaussian feature to the image feature Z, and the process may be a fixed Markov chain process, and the original data distribution is changed into a normal distribution by continuously adding Gaussian noise.

The text encoding network 450 is configured to perform text encoding on the obtained description text 420 to obtain a corresponding text feature. In some embodiments, the text encoding network 450 may employ, but is not limited to, Contrastive Language‑Image Pre‑training (CLIP) model.

The denoising network 460 is configured to perform denoising process on the obtained noise added image feature Z_{T} according to the obtained text feature, to obtain a denoised image feature Z′. In the denoising network 460, under the constraint of the text feature, T times denoising prediction is performed on the noise image feature Z_{T} through the denoising process, to finally generate a latent space prediction vector Z′, that is, to generate the prediction image feature Z′. The text feature is used to constrain the denoising of the noise image feature Z_{T} in the denoising process, so that the denoising network 460 outputs the prediction image feature Z′ related to the input description text 420 after T times denoising.

The image decoding network 450 is configured to decode the obtained denoised image feature (that is, the latent space prediction vector Z′) to obtain a prediction image corresponding to the input text 420, that is, an output image 480.

For the diffusion model, the noise level associated with the noise addition and denoising processes directly affects the performance of the image generation model.

With continued reference to FIGS. 2 and 3, in some embodiments, a first signal-to-noise ratio is used in the training 220-0 of the first image generation model, and a second signal-to-noise ratio is used in the training of the trained first image generation model 220-1 using the second training data 210. The second signal-to-noise ratio is different from the first signal-to-noise ratio.

In some embodiments, the second signal-to-noise ratio is less than the first signal-to-noise ratio. That is, in the process of training the first image generation model 220-1 using the second training data 210, more noise may be added to the image. This enables the second image generation model 230-0 to learn to add more details under high noise conditions, thereby achieving better performance in super-resolution tasks.

In some embodiments, a ratio of the first signal-to-noise ratio to the second signal-to-noise ratio is positively correlated with a ratio of the second resolution to the first resolution. For example, the first resolution is 512 × 512, the second resolution is 1024 × 1024, the first signal-to-noise ratio is a, and the second signal-to-noise ratio is a/4. It should be understood that the specific values or ratios of resolution and noise recited herein are illustrative only and are not intended to be limiting in any way.

In some embodiments, a first signal-to-noise ratio is used in the training 220-0 of the first image generation model, and a third signal-to-noise ratio is used in the process of training the second image generation model 230-0 with the second reward model 260. The third signal-to-noise ratio is different from the first signal-to-noise ratio. The third signal-to-noise ratio may be the same as the second signal-to-noise ratio, or may be different from the second signal-to-noise ratio.

In some embodiments, the third signal-to-noise ratio is less than the first signal-to-noise ratio. That is, in the process of training the second image generation model 230-0 with the second reward model 260, more noise may be added to the image. This enables the second image generation model 220-1 to learn to add more details under high noise conditions, thereby achieving better performance in super-resolution tasks.

In some embodiments, a ratio of the first signal-to-noise ratio to the third signal-to-noise ratio is positively correlated with a ratio of the second resolution to the first resolution. For example, the first resolution is 512 × 512, the second resolution is 1024 × 1024, the first signal-to-noise ratio is a, and the third signal-to-noise ratio is a/4. It should be understood that the specific values or ratios of resolution and noise recited herein are illustrative only and are not intended to be limiting in any way.

For the diffusion model, during the noise addition stage, the noise of the image gradually increases with time steps, and during the denoising stage, the noise of the image gradually decreases with time steps. In the super-resolution task, the stage related to the texture and details of the image is mainly the stage corresponding to the earlier time step of the model. For example, if the diffusion model diffuses 1000 steps, the first 500 steps of the denoising network may be more mainly related to the type of the image, and the last 500 steps are mainly related to the details and texture of the image. Therefore, in the super-resolution task, the focus is on the stages related to the details and the texture of the image, focusing on sampling and optimizing these stages, so that the second image generation model can focus on adding the details and the texture information.

With continued reference to FIG. 2, in some embodiments of the present disclosure, when the second image generation model 230-0 is trained with the second reward model 260, a set of time steps are sampled from a plurality of time steps according to such sampling strategy. The sampling strategy enables a sampling probability of a time step with a low noise level (for example, the time step during the denoising stage close to the prediction image feature Z′) to be greater than a sampling probability of a time step with a high noise level (for example, the time step during the denoising stage close to the noise image feature Z_{T} ). In some embodiments, when the second image generation model 230-0 is trained with the second reward model 260, a power sampling strategy is used.

As briefly mentioned above, in some embodiments, the image generation model uses the diffusion model, and the training of the diffusion model is completed in latent space, so that the computational power and storage capacity required for training are relatively small. However, when the second image generation model 230-0 is trained with the second reward model 260, it is necessary to compute the loss function in the image space, and the high-resolution image makes the computational power and storage capacity required for training very large, so that the graphics memory optimization becomes a necessary operation.

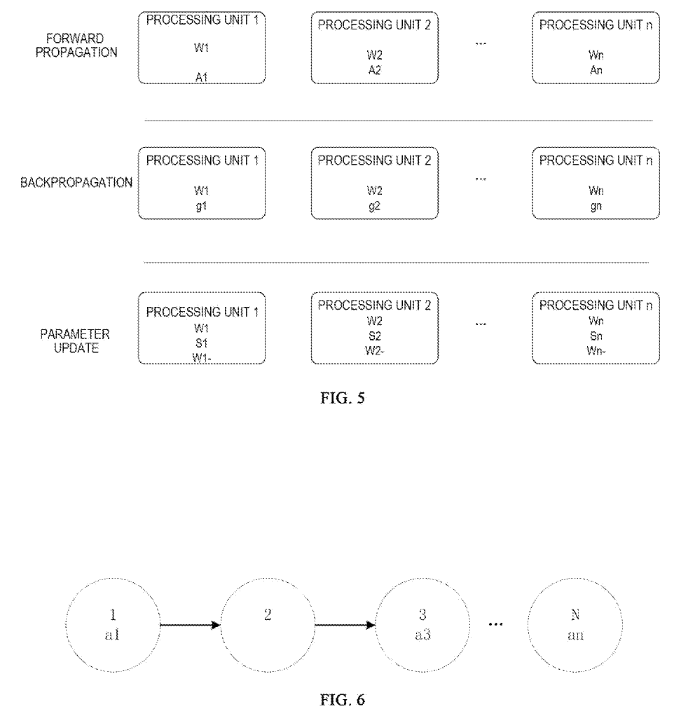

FIG. 5 illustrates a schematic diagram of an example of a graphics memory optimization scheme according to some embodiments of the present disclosure. As shown in FIG. 5, in some embodiments, the electronic device includes a plurality of processing units, for example, including processing units 1-n. When the second image generation model 230-0 is trained with the second reward model 260, the training data of the second image generation model 230-0 may be divided onto n processing units. The n processing units each process a portion of the training data in the training process. Correspondingly, the n processing units respectively update the corresponding training data during the parameter update stage.

In some embodiments, the training data includes a parameter, such as a weight w, of the second image generation model 230-0. In some embodiments, the training data may also include intermediate state values of the training of the second image generation model 230-0, such as gradient and optimizer state.

As an example, the second image generation model 230-0 includes an n-layer network that includes weight parameters W1, W2,···, and Wn, respectively· As shown in FIG. 5, when the second image generation model 230-0 is trained with the second reward model 260, in the forward propagation process, the weights W1, W2,···, and Wn respectively corresponding to the n-layer network are respectively divided on the processing unit 1, the processing unit 2, ···, and the processing unit n. In backpropagation, the processing unit 1, the processing unit 2,···, and the processing unit n respectively process and/or store the respective corresponding gradients g1, g2···, gn. During the parameter update stage, the processing unit 1, the processing unit 2,···, and the processing unit n respectively process and/or store respective corresponding optimizer states S1, S2,···, Sn, and weights W1-, W2-, and Wn. Therefore, each processing unit only processes and stores a portion of the training data, and the graphics memory capacity required is greatly reduced. Therefore, the problem of graphics memory explosion in the training process can be avoided. Meanwhile, the training stability is also improved, and it is possible to train image generation model of larger scale.

It should be understood that FIG. 5 is merely an example of a graphics memory optimization, which does not constitute a limitation on the present disclosure. In other embodiments of the present disclosure, other similar strategies may be employed. For example, it is possible to divide only the optimizer state of the second image generation model 230-0 onto the multiple processing units. For another example, it is possible to divide only the optimizer state and the gradient of the second image generation model 230-0 onto the multiple processing units. For another example, as shown in FIG. 5, the weight, the optimizer state, and the gradient of the second image generation model 230-0 are all divided onto the plurality of processing units.

It should also be understood that the division of the trained data is not limited to the manner shown in FIG. 5, but may be a variety of suitable manners, for example, processing and storing a set of training data on each processing unit, and the set of training data is a subset of the total training data of the second image generation model.

FIG. 6 illustrates a schematic diagram of another example of a graphics memory optimization scheme according to some embodiments of the present disclosure.

In some embodiments, for example, in order to reduce the graphics memory capacity required for training the second image generation model 230-0 with the second reward model 260, or in order to train the second image generation model 230-0 of a larger scale, when the second image generation model 230-0 is trained with the second reward model 260, intermediate state values of a first portion of the intermediate state values of the second image generation model is stored in the forward propagation process, and intermediate state values of a second portion of the intermediate state values of the second image generation model is not stored; and in the backpropagation process, the intermediate state values of the second portion is determined based on the intermediate state values of the first portion.

As shown in FIG. 6, by way of example, the second image generation model includes nodes 1-N, and the nodes 1-N generate activation values a1 to an during training, respectively. However, a1, a3,···, an are simply stored in the forward propagation process. In backpropagation, when a2, a4···, an-1 are required, a2, a4···, an-1 are then recomputed based on a1, a3,···, an. In this way, since only a portion of the activation values are stored, the required graphics memory is greatly reduced, and thus a larger scale second image generation model can be trained.

It should be understood that FIG. 6 only schematically illustrates how to store the intermediate state values of the first portion of the intermediate state values of the second image generation model without storing the intermediate state values of the second portion of the intermediate state values of the second image generation model in the forward propagation process; and in the backpropagation process, the intermediate state values of the second portion is determined based on the intermediate state values of the first portion, which does not constitute a limitation on the present disclosure. The present disclosure may store a portion of intermediate state values in various suitable ways as needed. That is, which of the intermediate state values of the second image generation model are stored and which are not stored is not limited to the division manner shown in FIG. 6, and may be in various suitable manners.

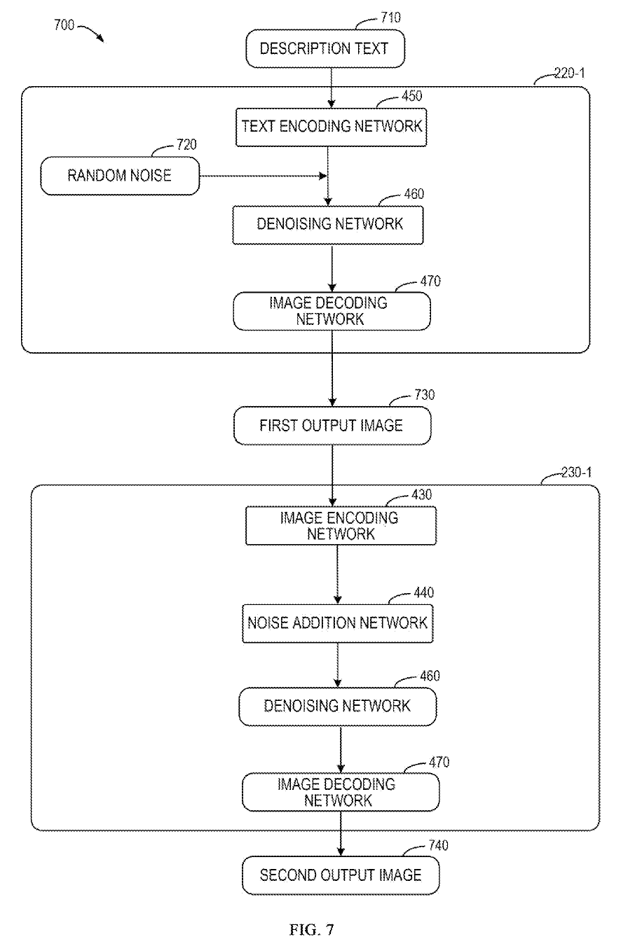

FIG. 7 illustrates a schematic architectural diagram of a model for image generation according to some embodiments of the present disclosure. As shown in FIG. 7, a model 700 for image generation may be implemented or included in the electronic device 150.

In some embodiments, the electronic device obtains description text 710 for the image generation target, and then encodes the description text 710 by using the text encoding network 450 of the first image generation model 220-1 to obtain the text feature. The text feature and random noise 720 are then input to the denoising network 460 of the first image generation model 220-1, the prediction image feature is obtained by using the denoising network 460, and then first output image 730 is obtained by the image decoding network 470 of the first image generation model 220-1.

Next, the electronic device inputs the first output image 730 into the image encoding network 730 of the second image generation model 230-1 to obtain image features. The second output image 740 is then obtained by the noise addition network 440, the denoising network 460, and the image decoding network 470 of the second image generation model 230-1 based on the image features. A resolution of the second output image 740 is greater than a resolution of the first output image 730.

### Example Processes

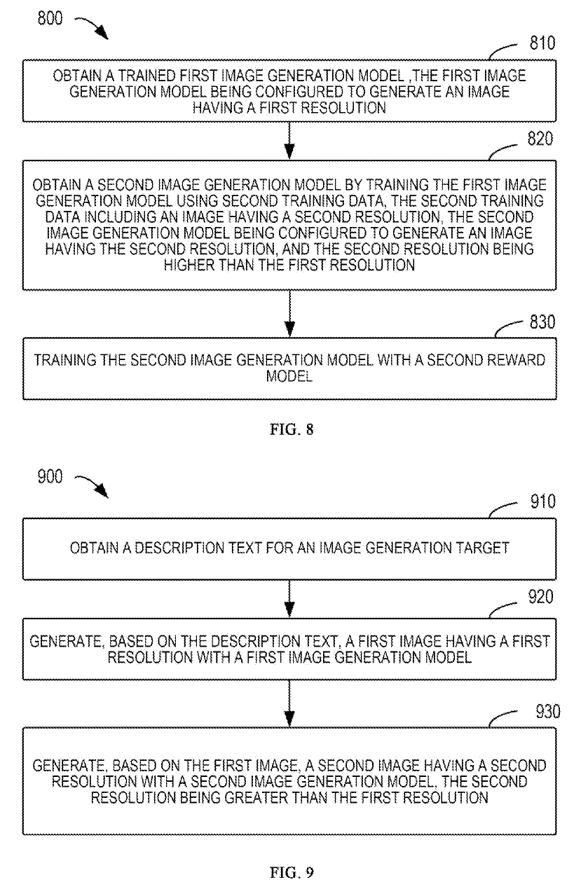

FIG. 8 illustrates a flowchart of a process 800 for image generation according to some embodiments of the present disclosure. Process 800 may be implemented or included in electronic device 140. The process 800 is described below with reference to FIG. 8.

At block 810, obtaining a trained first image generation model ,the first image generation model being configured to generate an image having a first resolution.

In some embodiments, the obtaining the trained first image generation model includes:

training an initial image generation model using first training data, the first training data including the image having the first resolution; and

training the initial image generation model with a first reward model to obtain the first image generation model.

At block 820, obtaining a second image generation model by training the first image generation model using second training data, the second training data including an image having a second resolution, the second image generation model being configured to generate an image having the second resolution, and the second resolution being higher than the first resolution.

At block 830, training the second image generation model with a second reward model.

In some embodiments, the first image generation model and the second image generation model each include a diffusion model, a first signal-to-noise ratio is used in training of the first image generation model, and a second signal-to-noise ratio used in at least one of the following is less than the first signal-to-noise ratio:

training of the first image generation model using the second training data, or

training of the second image generation model with the second reward model.

In some embodiments, a ratio of the first signal-to-noise ratio to the second signal-to-noise ratio is positively correlated with a ratio of the second resolution to the first resolution.

In some embodiments, training the second image generation model with the second reward model includes:

dividing training data for the second image generation model to a plurality of processing units, such that each processing unit of the plurality of processing units processes a portion of the training data, the training data including a model parameter and intermediate state values of training; and

updating a corresponding portion of the training data in the plurality of processing units, respectively.

In some embodiments, training the second image generation model with the second reward model includes:

storing, during a forward propagation process of the second image generation model, intermediate state values of a first portion of the intermediate state values of the second image generation model without storing intermediate state values of a second portion of the intermediate state values of the second image generation model; and

determining, during a backpropagation process of the second image generation model, the intermediate state values of the second portion based on the intermediate state values of the first portion.

In some embodiments, the second image generation model corresponds to a denoising process and a noise addition process involving a plurality of time steps, and the training the second image generation model with the second reward model includes:

sampling a set of time steps from the plurality of time steps according to a preset sampling strategy, where the sampling strategy enables a sampling probability of a time step with a low noise level to be greater than a sampling probability of a time step with a high noise level; and

training the second image generation model with the second reward model based on a noise addition operation and a denoising operation in the set of time steps.

In some embodiments, a model parameter is sampled by using a power sampling strategy during the training of the second image generation model with the second reward model.

FIG. 9 illustrates a flowchart of a process 900 for image generation according to some embodiments of the present disclosure. Process 900 may be implemented or included at electronic device 150. The process 900 is described below with reference to FIG. 9.

At block 910, obtaining a description text for an image generation target.

At block 920, generating, based on the description text, a first image having a first resolution with a first image generation model.

At block 930, generating, based on the first image, a second image having a second resolution with a second image generation model, the second resolution being greater than the first resolution, and the second image generation model being trained according to the method of the present disclosure.

### Example Apparatus and Device

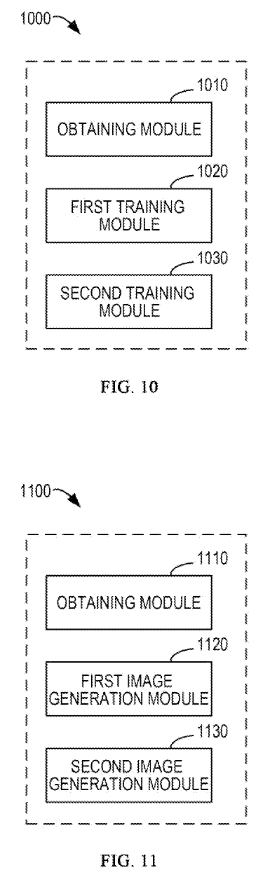

FIG. 10 illustrates a block diagram of an apparatus 1000 for image generation according to some embodiments of the present disclosure. The apparatus 1000 may be implemented as or included in the electronic device 140. The various modules/components in the apparatus 1000 may be implemented by hardware, software, firmware, or any combination thereof.

As shown in FIG. 10, the apparatus 1000 includes an obtaining module 1010 configured to obtain a trained first image generation model, the first image generation model is configured to generate an image having a first resolution. The apparatus 1000 further includes a first training module 1020 configured to obtain a second image generation model by training the first image generation model using second training data, the second training data including an image having a second resolution, the second image generation model is configured to generate an image having the second resolution, and the second resolution being higher than the first resolution. The apparatus 1000 further includes a second training module 1030 configured to train the second image generation model with a second reward model.

In some embodiments, the first image generation model and the second image generation model each include a diffusion model, the obtaining module 1010 is further configured to use a first signal-to-noise ratio in training of the first image generation model, the first training module 1020 is further configured to use a second signal-to-noise ratio less than the first signal-to-noise ratio in training of the first image generation model using the second training data, and/or the second training module 1030 is further configured to use a second signal-to-noise ratio less than the first signal-to-noise ratio in training of the second image generation model with the second reward model.

In some embodiments, a ratio of the first signal-to-noise ratio to the second signal-to-noise ratio is positively correlated with a ratio of the second resolution to the first resolution.

In some embodiments, the second training module 1030 is further configured to:

divide training data for the second image generation model to a plurality of processing units such that each processing unit of the plurality of processing units processes a portion of the training data, where the training data includes a model parameter and intermediate state values of training; and

update a corresponding portion of the training data in the plurality of processing units, respectively.

In some embodiments, the second training module 1030 is further configured to:

store, during a forward propagation process of the second image generation model, intermediate state values of a first portion of the intermediate state values of the second image generation model without storing intermediate state values of a second portion of the intermediate state values of the second image generation model; and

determine, during a backpropagation process of the second image generation model, the intermediate state values of the second portion based on the intermediate state values of the first portion.

In some embodiments, the second image generation model corresponds to a denoising process and a noise addition process involving a plurality of time steps, and the second training module 1030 is further configured to:

sample a set of time steps from the plurality of time steps according to a preset sampling strategy, where the sampling strategy enables a sampling probability of a time step with a low noise level to be greater than a sampling probability of a time step with a high noise level; and

train the second image generation model with the second reward model based on a noise addition operation and a denoising operation in the set of time steps.

In some embodiments, the second training module 1030 is further configured to sample a model parameters by using a power sampling strategy.

In some embodiments, the obtaining module 1010 is further configured to:

train an initial image generation model using first training data, the first training data including the image having the first resolution; and

train the initial image generation model with a first reward model to obtain the first image generation model.

FIG. 11 illustrates a block diagram of an apparatus 1100 for image generation according to some embodiments of the present disclosure. The apparatus 1100 may be implemented as or included in the electronic device 150. The various modules/components in the apparatus 1100 may be implemented by hardware, software, firmware, or any combination thereof.

As shown in FIG. 11, the apparatus 1100 includes an obtaining module 1110 configured to obtain a description text for an image generation target. The apparatus 1100 further includes a first image generation module 1120 configured to generate, based on the description text, a first image having a first resolution with a first image generation model. The apparatus 1100 further includes a second image generation module 1130 configured to generate, based on the first image, a second image having a second resolution with a second image generation model, the second resolution is greater than the first resolution, and the second image generation model is trained by the apparatus shown in FIG. 10.

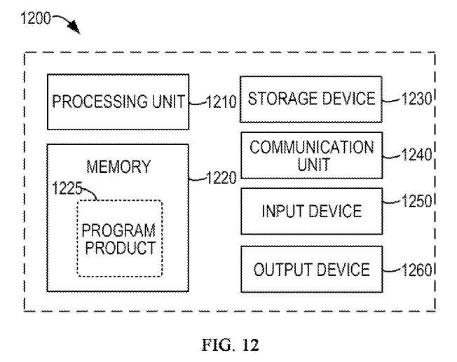

FIG. 12 illustrates a block diagram of an electronic device 1200 in which one or more embodiments of the present disclosure may be implemented. It should be understood that the electronic device 1200 illustrated in FIG. 12 is merely illustrative and should not constitute any limitation on the functionality and scope of the embodiments described herein. The electronic device 1200 shown in FIG. 12 may be configured to implement the electronic device 110 in FIG. 1.

As shown in FIG. 12, the electronic device 1200 is in the form of a general-purpose electronic device. Components of the electronic device 1200 may include, but are not limited to, one or more processors or processing units 1210, a memory 1220, a storage device 1230, one or more communication units 1240, one or more input devices 1250, and one or more output devices 1260. The processing unit 1210 may be an actual or virtual processor and capable of performing various processes according to programs stored in the memory 1220. In multiprocessor systems, multiple processing units execute computer-executable instructions in parallel to improve parallel processing capabilities of electronic device 1200.

The electronic device 1200 typically includes a plurality of computer storage media. Such media may be any available media accessible by the electronic device 1200, including, but not limited to, volatile and non-volatile media, removable and non-removable media. The memory 1220 may be volatile memory (e.g., a register, a cache, a random access memory (RAM)), a non-volatile memory (e.g., read-only memory (ROM), an electrically erasable programmable read-only memory (EEPROM), flash memory), or some combination thereof. Storage device 1230 may be a removable or non-removable medium and may include a machine-readable medium, such as a flash drive, a magnetic disk, or any other medium, which may be used to store information and/or data and may be accessed within electronic device 1200.

The electronic device 1200 may further include additional removable/non-removable, volatile/non-volatile storage media. Although not shown in FIG. 12, a disk drive for reading from or writing to a removable, nonvolatile magnetic disk (e.g., a “floppy disk”) and an optical disk drive for reading from or writing to a removable, nonvolatile optical disk may be provided. In these cases, each drive may be connected to a bus (not shown) by one or more data media interfaces. The memory 1220 may include a computer program product 1225 having one or more program modules configured to perform various methods or actions of various implementations of the present disclosure.

The communications unit 1240 implements communications with other electronic device over a communications medium. Additionally, the functionality of components of the electronic device 1200 may be implemented in a single computing cluster or multiple computing machines capable of communicating over a communication connection. Thus, the electronic device 1200 may operate in a networked environment using logical connections to one or more other servers, network personal computers (PCs), or another network node.

The input device 1250 may be one or more input devices such as a mouse, a keyboard, a trackball, or the like. The output device 1260 may be one or more output devices, such as a display, a speaker, a printer, or the like. The electronic device 1200 may also communicate with one or more external devices (not shown) such as a storage device, a display device, or the like through the communication unit 1240 as needed, and communicate with one or more devices that enable a user to interact with the electronic device 1200, or communicate with any device (e.g., a network card, a modem, etc. ) that enables the electronic device 1200 to communicate with one or more other electronic devices. Such communication may be performed via an input/output (I/O) interface (not shown).

According to example implementations of the present disclosure, there is provided a computer-readable storage medium having computer-executable instructions stored thereon, where the computer-executable instructions are executed by a processor to implement the method described above.

According to example implementations of the present disclosure, a computer program product is further provided, the computer program product is tangibly stored on a non-transitory computer-readable medium and includes computer-executable instructions, and the computer-executable instructions are executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowcharts and/or block diagrams, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, create means for implementing the functions/actions specified in one or more blocks of the flowchart and/or block diagram. These computer-readable program instructions may also be stored in a computer-readable storage medium that can direct a computer, a programmable data processing apparatus, and/or other devices to function in a particular manner, such that the computer-readable medium storing instructions includes an article of manufacture including instructions which implement various aspects of the functions/actions specified in one or more blocks of the flowchart and/or block diagram.

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed, when being executed on a computer, other programmable data processing apparatus, or other devices, implement the functions/actions specified in one or more blocks of the flowchart and/or block diagram.

The flowcharts and block diagrams in the drawings illustrate the architecture, functionality, and operations of possible implementations of systems, methods, and computer program products according to various implementations of the present disclosure. In this regard, each block in the flowchart or block diagram may represent a module, program segment, or a portion of an instruction that includes one or more executable instructions for implementing the specified logical function. In some alternative implementations, the functions marked in the blocks may also occur in a different order than those marked in the figures. For example, two consecutive blocks may actually be performed in parallel, or they may sometimes be performed in reverse order, depending on the function involved. It should also be noted that each block in the block diagrams and/or flowchart, as well as combinations of blocks in the block diagrams and/or flowchart, may be implemented using a dedicated hardware-based system that performs the specified functions or actions, or may be implemented using a combination of dedicated hardware and computer instructions.

Various implementations of the present disclosure have been described above, the foregoing description is illustrative, not exhaustive, and the present disclosure is not limited to the implementations as disclosed. Many modifications and variations will be apparent to those of ordinary skill in the art without departing from the scope and spirit of the implementations as described. The selection of the terms used herein is intended to best explain the principles of the implementations, practical applications, or improvements to techniques in the marketplace, or to enable those skilled in the art to understand the various implementations disclosed herein.

1. A method for image generation, comprising:
obtaining a trained first image generation model, the first image generation model being configured to generate an image having a first resolution;
obtaining a second image generation model by training the first image generation model using second training data, the second training data comprising an image having a second resolution, the second image generation model being configured to generate an image having the second resolution, and the second resolution being higher than the first resolution; and
training the second image generation model with a second reward model.

2. The method of claim 1, wherein the first image generation model and the second image generation model each comprise a diffusion model, a first signal-to-noise ratio is used in training of the first image generation model, and a second signal-to-noise ratio used in at least one of the following is less than the first signal-to-noise ratio:
training of the first image generation model using the second training data, or
training of the second image generation model with the second reward model.

3. The method of claim 2, wherein a ratio of the first signal-to-noise ratio to the second signal-to-noise ratio is positively correlated with a ratio of the second resolution to the first resolution.

4. The method of claim 1, wherein training the second image generation model with the second reward model comprises:
dividing training data for the second image generation model to a plurality of processing units, such that each processing unit of the plurality of processing units processes a portion of the training data, wherein the training data comprises a model parameter and intermediate state values of training; and
updating a corresponding portion of the training data in the plurality of processing units, respectively.

5. The method of claim 1, wherein training the second image generation model with the second reward model comprises:
storing, during a forward propagation process of the second image generation model, intermediate state values of a first portion of the intermediate state values of the second image generation model without storing intermediate state values of a second portion of the intermediate state values of the second image generation model; and
determining, during a backpropagation process of the second image generation model, the intermediate state values of the second portion based on the intermediate state values of the first portion.

6. The method of claim 1, wherein the second image generation model corresponds to a denoising process and a noise addition process involving a plurality of time steps, and the training the second image generation model with the second reward model comprises:
sampling a set of time steps from the plurality of time steps according to a preset sampling strategy, wherein the sampling strategy enables a sampling probability of a time step with a low noise level to be greater than a sampling probability of a time step with a high noise level; and
training the second image generation model with the second reward model based on a noise addition operation and a denoising operation in the set of time steps.

7. The method of claim 6, wherein a model parameter is sampled by using a power sampling strategy during the training of the second image generation model with the second reward model.

8. The method of claim 1, wherein the obtaining the trained first image generation model comprises:
training an initial image generation model using first training data, the first training data comprising the image having the first resolution; and
training the initial image generation model with a first reward model to obtain the first image generation model.

9. A method for generating an image, comprising:
obtaining a description text for an image generation target;
generating, based on the description text, a first image having a first resolution with a first image generation model; and
generating, based on the first image, a second image having a second resolution with a second image generation model, the second resolution being greater than the first resolution, and the second image generation model being trained according to acts comprising:
obtaining a trained first image generation model, the first image generation model being configured to generate an image having a first resolution;
obtaining a second image generation model by training the first image generation model using second training data, the second training data comprising an image having a second resolution, the second image generation model being configured to generate an image having the second resolution, and the second resolution being higher than the first resolution; and
training the second image generation model with a second reward model.

10. The method of claim 9, wherein the first image generation model and the second image generation model each comprise a diffusion model, a first signal-to-noise ratio is used in training of the first image generation model, and a second signal-to-noise ratio used in at least one of the following is less than the first signal-to-noise ratio:
training of the first image generation model using the second training data, or
training of the second image generation model with the second reward model.

11. The method of claim 10, wherein a ratio of the first signal-to-noise ratio to the second signal-to-noise ratio is positively correlated with a ratio of the second resolution to the first resolution.

12. The method of claim 9, wherein training the second image generation model with the second reward model comprises:
dividing training data for the second image generation model to a plurality of processing units, such that each processing unit of the plurality of processing units processes a portion of the training data, wherein the training data comprises a model parameter and intermediate state values of training; and
updating a corresponding portion of the training data in the plurality of processing units, respectively.

13. An electronic device, comprising:
at least one processor; and
at least one memory coupled to the at least one processor and storing instructions for execution by the at least one processor, the instructions, when executed by the at least one processor, causing the electronic device to perform acts comprising:
obtaining a trained first image generation model, the first image generation model being configured to generate an image having a first resolution;
obtaining a second image generation model by training the first image generation model using second training data, the second training data comprising an image having a second resolution, the second image generation model being configured to generate an image having the second resolution, and the second resolution being higher than the first resolution; and
training the second image generation model with a second reward model.

14. The electronic device of claim 13, wherein the first image generation model and the second image generation model each comprise a diffusion model, a first signal-to-noise ratio is used in training of the first image generation model, and a second signal-to-noise ratio used in at least one of the following is less than the first signal-to-noise ratio:
training of the first image generation model using the second training data, or
training of the second image generation model with the second reward model.

15. The electronic device of claim 14, wherein a ratio of the first signal-to-noise ratio to the second signal-to-noise ratio is positively correlated with a ratio of the second resolution to the first resolution.

16. The electronic device of claim 13, wherein training the second image generation model with the second reward model comprises:
dividing training data for the second image generation model to a plurality of processing units, such that each processing unit of the plurality of processing units processes a portion of the training data, wherein the training data comprises a model parameter and intermediate state values of training; and
updating a corresponding portion of the training data in the plurality of processing units, respectively.

17. The electronic device of claim 13, wherein training the second image generation model with the second reward model comprises:
storing, during a forward propagation process of the second image generation model, intermediate state values of a first portion of the intermediate state values of the second image generation model without storing intermediate state values of a second portion of the intermediate state values of the second image generation model; and
determining, during a backpropagation process of the second image generation model, the intermediate state values of the second portion based on the intermediate state values of the first portion.

18. The electronic device of claim 13, wherein the second image generation model corresponds to a denoising process and a noise addition process involving a plurality of time steps, and the training the second image generation model with the second reward model comprises:
sampling a set of time steps from the plurality of time steps according to a preset sampling strategy, wherein the sampling strategy enables a sampling probability of a time step with a low noise level to be greater than a sampling probability of a time step with a high noise level; and
training the second image generation model with the second reward model based on a noise addition operation and a denoising operation in the set of time steps.

19. The electronic device of claim 18, wherein a model parameter is sampled by using a power sampling strategy during the training of the second image generation model with the second reward model.

20. The electronic device of claim 13, wherein the obtaining the trained first image generation model comprises:
training an initial image generation model using first training data, the first training data comprising the image having the first resolution; and
training the initial image generation model with a first reward model to obtain the first image generation model.
